(19) United States
(12) Patent Application Publication
(10) Pub. No.: US 2004/0141532 A1
(43) Pub. Date: Jul. 22, 2004

(54) Multiplexer and usage thereof

(76) Inventors: Tsutomu Chikazawa, Yokohama (JP); Kohichiro Kajiwara, Yokohama (JP); Junichi Kawano, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/746,598

(22) Filed: Dec. 23, 2003

(30) Foreign Application Priority Data
Jan. 16, 2003 (JP) 2003-008378

(51) Int. Cl. H04J 3/04

(52) U.S. Cl. 370/535

(57) ABSTRACT

In a multiplexer and a usage thereof, a higher-order cross-connect of the multiplexer inputs a higher-order synchronous network signal from any of higher-order input channels to be cross-connected to any of higher-order output channels, a lower-order cross-connect inputs a lower-order signal, which can be multiplexed into the higher-order synchronous network signal, from any of lower-order input channels to be cross-connected to any of lower-order output channels, and a part of the higher-order output channels and a part of the lower-order input channels are mutually connected as well as a part of the lower-order output channels and a part of the higher-order input channels are mutually connected.

### BACKGROUND OF THE INVENTION

1. Field of the Invention

The present invention relates to a multiplexer and a usage thereof, and in particular to a multiplexer using a BLSR (Bidirectional Line Switched Ring) redundancy method and a usage of the multiplexer.

2. Description of the Related Art

SDH (Synchronous Digital Hierarchy) has been internationally standardized as a multiplexing method for a high speed transmission. Also, SONET (Synchronous Optical Network) corresponding to SDH has been standardized in the United States of America.

In the following description, mutually corresponding terms between SDH and SONET are indicated with SDH-related terms on the left side of/and SONET-related terms on the right side of /, such as in “STM/OC-n”, “AU/STS”, and “VC/VT”.

The BLSR redundancy method is known as a technology for improving reliability and operability/maintainability of a network.

The BLSR redundancy method requires a renewal processing of ring protection information upon addition or deletion of a node. There is a protection information management system for a ring transmission line capable of automatically performing such a renewal processing based on information set in nodes in a higher-order ring network (see e.g. patent document 1).

Also, since the BLSR redundancy method is related to redundancy of an AU/STS signal that is a higher-order synchronous network signal in the SDH/SONET, multiplexers equipped with an AU/STS signal cross-connecting function (hereinafter, occasionally referred to as higher-order cross-connecting function) have been developed for a multiplexer (hereinafter, occasionally referred to as node) used in a ring network using the BLSR redundancy method. Also, devices equipped with a cross-connecting function (hereinafter, occasionally referred to as lower-order cross-connecting function) for a VC/VT signal that is a lower-order signal and is multiplexed into the AU/STS signal have been also developed recently.

Firstly, procedures for adding and deleting a multiplexer having only a higher-order cross-connecting function to/from a ring network will now be described referring to FIGS. 9A-9D.

FIG. 9A shows an initial state wherein five transmission devices (nodes) 1-5 are connected in a ring-like manner with a transmission line 7 having a working line 7_W and a protection line 7_P as shown to compose a higher-order ring network. Also, a thick arrow in FIG. 9A shows a flow of an AU/STS signal 8.

In case of adding a node 6 between the nodes 1 and 5 in this ring network, if the transmission line between the nodes 1 and 5 is cut off in order to add the node 6, a loop-back control will be performed in accordance with the BLSR redundancy method. In this case, since a section between the nodes 1 and 5 is switched from the working line 7_W over to the protection line 7_P, the AU/STS signal 8 having passed through the nodes 2-1-5 in FIG. 9A passes through the nodes 2-1-2-3-4-5 in FIG. 9B.

In this state, when the node 6 is inserted into the transmission line between the nodes 1 and 5, physical connection is completed, and then the loop-back control is released as shown in FIG. 9C, the addition of the node 6 is completed.

The procedure for deleting a node from the ring network has only to follow a reverse procedure of the above. By physically cutting off the node 6 from the transmission line in the state of FIG. 9C, the loop-back control as shown in FIG. 9B will be performed in accordance with the BLSR redundancy method, so that by releasing the loop-back control after deleting the node 6 and connecting the transmission line between the nodes 1 and 5, the state of FIG. 9A will be achieved.

Thus, for the multiplexer having only the higher-order cross-connecting function, the node addition and deletion to/from the ring network can be performed without a service interruption.

It is to be noted that in each state shown in FIGS. 9A-9C, by paying attention to the node 6, it is found that the node 6 is in a state where the AU/STS signal has a through cross-connection.

In a ring-network, two STM/OC-n's are regarded as a pair, and a cross-connection from a certain channel of one STM/OC-n input to the same channel of the other STM/OC-n output is called a “through cross-connection”.

Namely, the node 6 which is an object of the addition or deletion in FIGS. 9A-9C has a through cross-connection of the AU/STS signal set during a transition period of the node addition or the node deletion.

This is because when adding the node 6, it is required to be in a through state without influence on in-service signals transmitted by the existing nodes 1 and 5. Also, when deleting the node 6, although service ends for signals added/dropped by the node 6, it is required to be in a through state without influence on the other signals.

Thus, in a prior art BLSR multiplexer, a through state has been achieved by setting the AU/STS signal to a through cross-connection at the time of node addition, and by preserving through cross-connections for signals other than the added/dropped signals at the time of node deletion.

[Patent document 1]

Japanese Patent Application Laid-open No.8-23342 (abstract, FIG. 4)

Procedures will now be described for addition and deletion of a multiplexer equipped with cross-connecting functions of a higher-order AU/STS signal as well as a lower-order VC/VT signal, namely, the multiplexer equipped with both of the higher-order cross-connecting function and the lower-order cross-connecting function.

In case the node 6 is such a multiplexer, after adding the node 6 to the ring network by the above-mentioned node addition procedure, it is required that the state shown in FIG. 9D is achieved in order to add/drop a VC/VT signal 9.

In this case, in the node 6, the setting of the AU/STS signal cross-connection must be once deleted and then setting of the VC/VT signal cross-connection is required to be performed.

Therefore, when adding the multiplexer equipped with both of the higher-order cross-connecting function and the lower-order cross-connecting function, a service interrupted state has been inevitable when changing the states from FIG. 9C to FIG. 9D.

Also, in case of deleting the node 6 from the state of FIG. 9D, when trying to delete the node 6 directly from the transmission line, a signal interruption occurs due to a “squelch”.

A “squelch” is a nullification of a path by the operation of inserting an AIS (Alarm Indication Signal) from the node that is detecting a failure in order to avoid a miscommunication. A “squelch” is realized by managing squelch information indicating from which node the signal is added and at which node the signal is dropped with a squelch table.

While the squelch table in the state of FIG. 9A manages that the section between the nodes 2 and 5 is connected, the squelch table in the state of FIG. 9D manages that there are two connections such as sections between the nodes 2 and 6 as well as between the nodes 6 and 5. Namely, in the state of FIG. 9D, the connection of the section between the nodes 2 and 5 is not managed.

From this state, when the node 6 and the transmission line 7 are disconnected and the loop-back state of FIG. 9B is formed, connection of the section between the nodes 2 and 5, which inherently does not exist, is generated. However, since it is determined that the signal of the node 2 does not reach the node 6 and the signal of the node 5 does not reach the node 6 according to the recognition based on the squelch table, the nodes 1 and 5 respectively insert therein the AIS signal, so that the loop-back path is squelched and a signal interruption occurs.

Also, in order to avoid the above-mentioned squelch, the node 6 may be deleted after making an AU/STS signal a through cross-connected state as shown in FIG. 9C from the state of FIG. 9D. In order to do this, it is required that the setting of the VC/VT signal cross-connection is once deleted and then the setting of the AU/STS signal cross-connection is performed. Also in this case, the service interruption will occur.

Thus, in the higher-order ring network using the BLSR redundancy method, it has not been possible by the prior art procedures to add and delete the multiplexer equipped with both of the higher-order cross-connecting function and the lower-order cross-connecting function with the same procedure as the multiplexer having only the higher-order cross-connecting function.

### SUMMARY OF THE INVENTION

It is accordingly an object of the present invention to provide a multiplexer equipped with both of the higher-order cross-connecting function and the lower-order cross-connecting function as well as usage of the multiplexer, namely, a method of adding and deleting a multiplexer to/from a ring network without involving a service interruption.

In order to achieve the above-mentioned object, a multiplexer according to the present invention comprises: a higher-order cross-connect for inputting a higher-order synchronous network signal from any of higher-order input channels to be cross-connected to any of higher-order output channels; and a lower-order cross-connect for inputting a lower-order signal, which can be multiplexed into the higher-order synchronous network signal, from any of lower-order input channels to be cross-connected to any of lower-order output channels; a part of the higher-order output channels and a part of the lower-order input channels being mutually connected as well as a part of the lower-order output channels and a part of the higher-order input channels being mutually connected.

Namely, in a multiplexer according to the present invention, a higher-order cross-connect inputs a higher-order synchronous network signal (e.g. AU signal in SDH and STS signal in SONET) from any of higher-order input channels to be cross-connected to any of higher-order output channels.

Also, a lower-order cross-connect inputs a lower-order signal (e.g. VC signal in SDH and VT signal in SONET) which can be multiplexed into the higher-order synchronous network signal from any of lower-order input channels to be cross-connected to any of lower-order output channels.

A part of the higher-order output channels and a part of the lower-order input channels are mutually connected as well as a part of the lower-order output channels and a part of the higher-order input channels are mutually connected.

Thus, in the higher-order cross-connect and the lower-order cross-connect, a higher-order through cross-connection and a lower-order through cross-connection can be set, respectively. Specifically, in the lower-order cross-connect, a lower-order through cross-connection can be set between the lower-order input channel and the lower-order output channel respectively connected to the higher-order output channel and the higher-order input channel.

Also, the higher-order cross-connect is able to cross-connect from the higher-order input channel connected to the lower-order output channel to any of the higher-order output channels and from any of the higher-order output channels to the higher-order input channel connected to the lower-order input channel.

Thus, when adding the multiplexer to a ring network and the like, the multiplexer is added to the ring network in a state where the higher-order through cross-connection is set, by the same procedure as the prior art, and then by mutually switching the cross-connection settings in the higher-order cross-connect and the lower-order cross-connect, it is made possible to switch over from a higher-order through cross-connection to a lower-order through cross-connection without involving a service interruption.

Also, when deleting a multiplexer from the ring network and the like, after switching from the lower-order through connection over to the higher-order through connection without involving a service interruption, by switching over the cross-connection setting of the higher-order cross-connect, it is made possible to delete the multiplexer from the ring network and the like by the same procedure as the prior art.

Thus, in the ring network and the like, it is made possible to add and delete a multiplexer equipped with both of the higher-order cross-connecting function and the lower-order cross-connecting function without involving a service interruption.

Also, upon addition of the multiplexer to a higher-order ring network, after being inserted into the ring network in a state where the higher-order cross-connect has established a through cross-connection between a first higher-order input channel and a first higher-order output channel the higher-order cross-connect may cross-connect a signal from the first higher-order input channel to be also branched to a second higher-order output channel different from the first higher-order output channel, the lower-order cross-connect may establish a through cross-connection between a lower-order input channel connected to the second higher-order output channel and a lower-order output channel connected to a second higher-order input channel different from the first higher-order input channel, and thereafter the higher-order cross-connect may switch an input side corresponding to the first higher-order output channel from the first higher-order input channel over to the second higher-order input channel.

Namely, in a first state of adding the multiplexer to the ring network, the higher-order cross-connect establishes a through cross-connection between a first higher-order input channel and a first higher-order output channel, and after the multiplexer has been inserted into the ring network, as a second state, the higher-order cross-connect cross-connects so as to branch a signal from the first higher-order input channel to a second higher-order output channel different from the first higher-order output channel.

Next, as a third state, the lower-order cross-connect establishes a through cross-connection between a lower-order input channel connected to the second higher-order output channel and a lower-order output channel connected to a second higher-order input channel different from the first higher-order input channel. Moreover, as a fourth state, the higher-order cross-connect switches an input side corresponding to the first higher-order output channel from the first higher-order input channel over to the second higher-order input channel.

Thus, after inserting the multiplexer in the first state where the higher-order through cross-connection is set, by changing the states from the second state to the fourth state, it is made possible to switch the higher-order through cross-connection over to the lower-order through cross-connection without a service interruption, thereby enabling the multiplexer to be added to the ring network and the like without involving a service interruption.

Also, upon deletion of the multiplexer from the ring network, the higher-order cross-connect may switch the input side of a cross-connection corresponding to the first higher-order output channel from the second higher-order input channel over to the first higher-order input channel to establish a through cross-connection.

Namely, when deleting the multiplexer from the ring network, in order to establish a through cross-connection between the first higher-order input channel and the first higher-order output channel, the higher-order cross-connect switches the input side of a cross-connection corresponding to the first higher-order output channel from the second higher-order input channel over to the first higher-order input channel.

Thus, it is made possible to switch the lower-order through cross-connection over to the higher-order cross-connection without a service interruption, thereby enabling the multiplexer to be deleted from the ring network and the like without involving a service interruption.

Also, the higher-order cross-connect may delete the cross-connection between the first higher-order input channel and the second higher-order output channel, and the lower-order cross-connect may delete the through cross-connection between the lower-order input channel and the lower-order output channel.

Moreover, the above-mentioned ring network may comprise a BLSR ring network.

Also, as a usage of the above-mentioned multiplexer, a method of adding the multiplexer to the ring network comprises: a first step of connecting the multiplexer to the ring network in a state where the higher-order cross-connect has established a through cross-connection between a first higher-order input channel and a first higher-order output channel; a second step executed by the higher-order cross-connect, after an execution of the first step, of cross-connecting a signal from the first higher-order input channel to be also branched to a second higher-order output channel different from the first higher-order output channel; a third step executed by the lower-order cross-connect, after an execution of the second step, of establishing a through cross-connection between a lower-order input channel connected to the second higher-order output channel and a lower-order output channel connected to a second higher-order input channel different from the first higher-order input channel; and a fourth step executed by the higher-order cross-connect, after an execution of the third step, of switching an input side corresponding to the first higher-order output channel from the first higher-order input channel over to the second higher-order input channel.

Namely, when adding the above-mentioned multiplexer to the ring network, in a first step, the multiplexer is connected to the ring network in the state where the higher-order cross-connect has established a through cross-connection between a first higher-order input channel and a first higher-order output channel.

Next, in the second step, the higher-order cross-connect cross-connects a signal from the first higher-order input channel to be also branched to a second higher-order output channel different from the first higher-order output channel. Moreover, in the third step, the lower-order cross-connect establishes a through cross-connection between a lower-order input channel connected to the second higher-order output channel and a lower-order output channel connected to a second higher-order input channel different from the first higher-order input channel. Finally, in the fourth step, the higher-order cross-connect switches an input side corresponding to the first higher-order output channel from the first higher-order input channel over to the second higher-order input channel.

Thus, after inserting the multiplexer into the ring network in a state where the higher-order through cross-connection is set by the same procedure as the prior art in the first step, it is made possible to switch the higher-order through cross-connection over to the lower-order through cross-connection without a service interruption from the second step until the fourth step, thereby enabling the multiplexer to be added to the ring network without involving a service interruption.

The above-mentioned first step may include a step of initializing the multiplexer.

Also, the above-mentioned first step may be preceded with a step of performing a loop-back control of the ring network, and the first step may include steps of physically connecting the multiplexer to the ring network, releasing the loop-back control, setting a node ID in the multiplexer, and restructuring a ring topology of the ring network.

Also, as a usage of the above-mentioned multiplexer, a method of deleting the multiplexer added to the ring network according to the above-mentioned method may comprise: a deletion preparing step, executed by the higher-order cross-connect, of switching the input side of a cross-connection corresponding to the first higher-order output channel from the second higher-order input channel over to the first higher-order input channel.

Namely, in the deletion preparing step before deleting the multiplexer from the ring network, in order to establish a through cross-connection between the first higher-order input channel and the first higher-order output channel, the higher-order cross-connect switches the input side of the cross-connection corresponding to the first higher-order input channel from the second higher-order input channel over to the first higher-order input channel.

Thus, it is made possible to switch the lower-order through cross-connection over to the higher-order through cross-connection without a service interruption, thereby enabling the multiplexer to be deleted from the ring network and the like without involving a service interruption.

Also, the above-mentioned method of deleting the multiplexer may further comprise the steps, after an execution of the deletion preparing step, of deleting the node ID of the multiplexer, restructuring a ring topology of the ring network, performing a loop-back control of the ring network, physically deleting the multiplexer, and releasing the loop back control.

Moreover, the above-mentioned method of deleting the multiplexer may further comprise the step executed by the higher-order cross-connect, after an execution of the deletion preparing step, of deleting the cross-connection between the first higher-order input channel and the second higher-order output channel, and the step executed by the lower-order cross-connect deleting the through cross-connection between the lower-order input channel and the lower-order output channel.

### BRIEF DESCRIPTION OF THE DRAWINGS

The above and other objects and advantages of the invention will be apparent upon consideration of the following detailed description, taken in conjunction with the involving drawings, in which the reference numerals refer to like parts throughout and in which:

FIGS. 1A-1D are block diagrams showing a node addition method (No.1) in a ring network using a multiplexer according to the present invention;

FIGS. 2A-2C are block diagrams showing a node addition method (No.2) in a ring network using a multiplexer according to the present invention;

FIGS. 3A-3F are block diagrams showing a node deletion method in a ring network using a multiplexer according to the present invention;

FIG. 4 is a block diagram showing a detailed arrangement of the node 6 shown in FIGS. 1A-1D, 2A-2C, and 3A-3F;

FIG. 5 is a block diagram showing a state (No.1) of the node 6 shown in FIGS. 1A-1D, 2A-2C, and 3A-3F;

FIG. 6 is a block diagram showing a state (No.2) of the node 6 shown in FIGS. 1A-1D, 2A-2C, and 3A-3F;

FIG. 7 is a block diagram showing a state (No.3) of the node 6 shown in FIGS. 1A-1D, 2A-2C, and 3A-3F;

FIG. 8 is a block diagram showing a state (No.4) of the node 6 shown in FIGS. 1A-1D, 2A-2C, and 3A-3F; and

FIGS. 9A-9D are block diagrams illustrating procedures for addition and deletion of a node to/from a ring network using a prior art multiplexer.

### DESCRIPTION OF THE EMBODIMENTS

Embodiments of the present invention will now be described in the following order: (1) Schematic procedure of node addition to ring network, (2) Schematic procedure of node deletion from ring network, and (3) Detailed arrangement of added/deleted node.

(1) Schematic Procedure of Node Addition to Ring Network

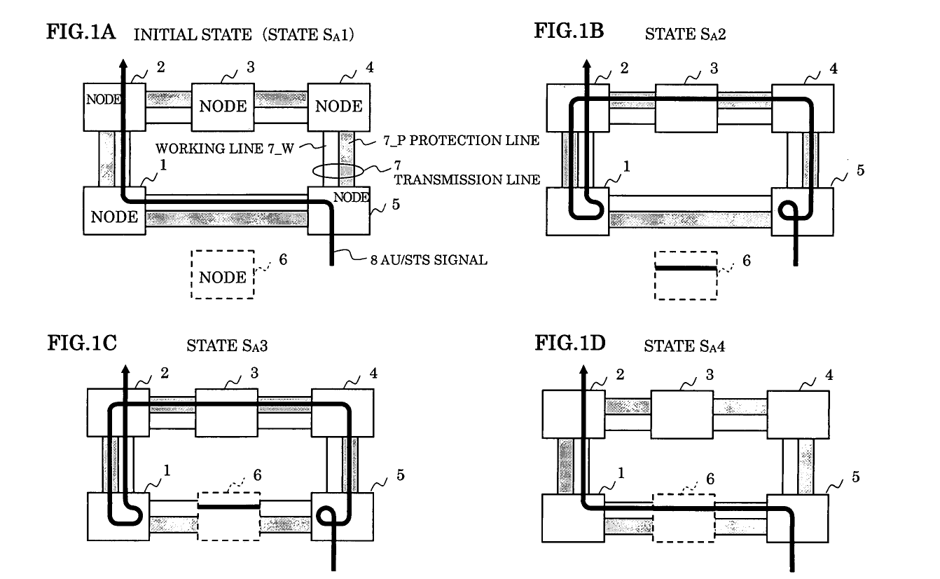

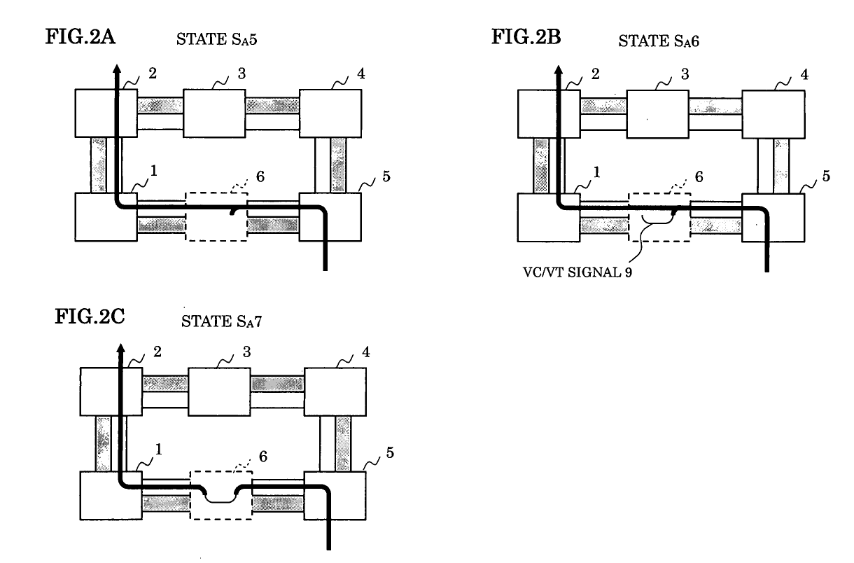

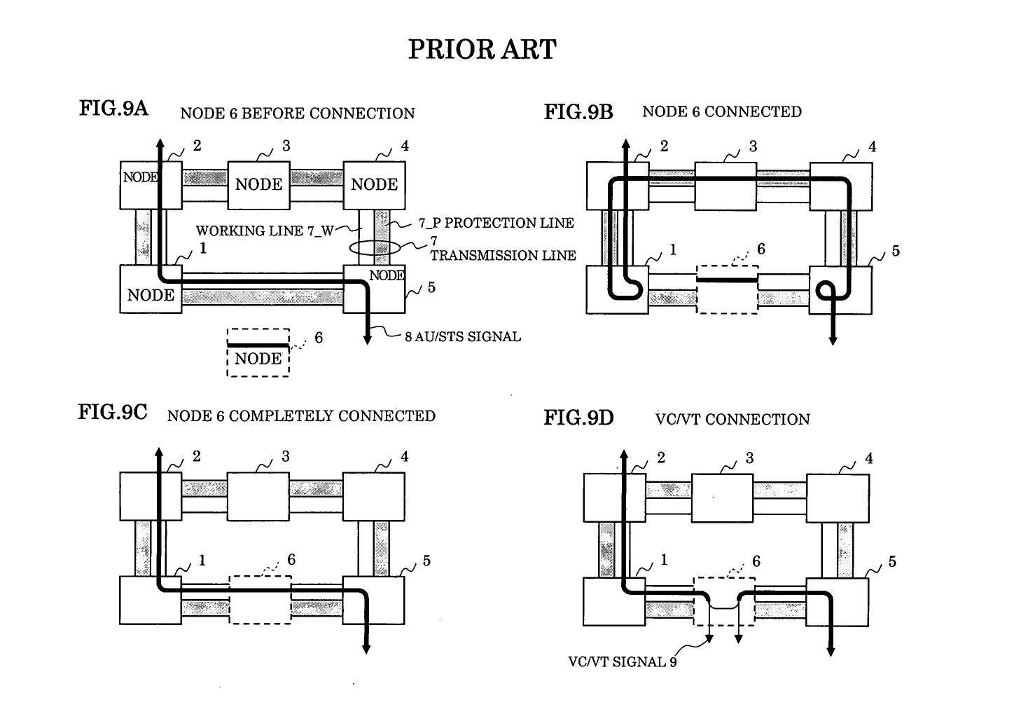

A schematic procedure of adding a multiplexer according to the present invention to a ring network will now be described referring to FIGS. 1A-1D and 2A-2C. An initial state S_{A}1 shown in FIG. 1A corresponds to the initial state of the prior art shown in FIG. 9A, and five nodes 1-5 are connected in a ring-like manner with a transmission line 7 having a working line 7_W and a protection line 7_P as shown in FIG. 1A, thereby composing a ring network.

Firstly, a procedure for adding a node 6, that is a multiplexer according to the present invention, to a section between the nodes 1-5 will be described. It is to be noted that the other nodes 1-5 are not necessarily the multiplexers according to the present invention.

Also, although a higher-order cross-connect and a lower-order cross-connect are not shown within the node 6 in FIGS. 1A-1D and 2A-2C, in the following description, it is supposed that the cross-connection setting of the AU/STS signal is performed by the higher-order cross-connect and the cross-connection setting of the VC/VT signal is performed by the lower-order cross-connect.

State S_{A}1: FIG. 1A

Firstly, as shown in FIG. 1A, the node 6 to be added is initialized. At this time, the node 6 has no setting of the higher-order cross-connection or the lower-order cross-connection.

State S_{A}2: FIG. 1B

A loop-back control as in FIG. 9B is performed and as shown by a thick line in the node 6, a higher-order through cross-connection that is the through cross-connection of the AU/STS signal is set in the node 6 to be added.

State S_{A}3: FIG. 1C

The node 6 to be added is connected to the existing ring network. Namely, the node 6 to be added is physically added.

State S_{A}4: FIG. 1D

Moreover, the loop-back control is released, a node ID is set in the node 6 to be added, and a ring topology is restructured. The above-mentioned processing in the state S_{A}4 is the same as the process of the prior art for adding the multiplexer having only the higher-order cross-connecting function to the ring network, which logically adds the node 6 to be added.

State S_{A}5: FIG. 2A

In the added node 6, the higher-order cross-connect “bridges” the AU/STS signal. The term “bridge” means to output an AU/STS signal which is through cross-connected in the higher-order cross-connect branched to a different output channel. In FIG. 2A, the AU/STS signal within the node 6 is shown to be branched.

State S_{A}6: FIG. 2B

In the added node 6, the lower-order cross-connect adds a lower-order through cross-connection that is a through cross-connection of a VC/VT signal 9. A thin line drawn at the tip of the branched AU/STS signal (thick line) within the node 6 shows the through cross-connection of the VC/VT signal 9.

State S_{A}7: FIG. 2C

In the added node 6, the higher-order cross-connect “rolls” the AU/STS signal. The term “roll” means to switch the input side channel of the existing cross-connection over to a different channel, thereby switching a higher-order through cross-connected state (see node 6 in the state S_{A}6 in FIG. 2B) over to a lower-order through cross-connected state (see node 6 in the state S_{A}7 in FIG. 2C).

(2) Schematic Procedure of Node Deletion from Ring Network

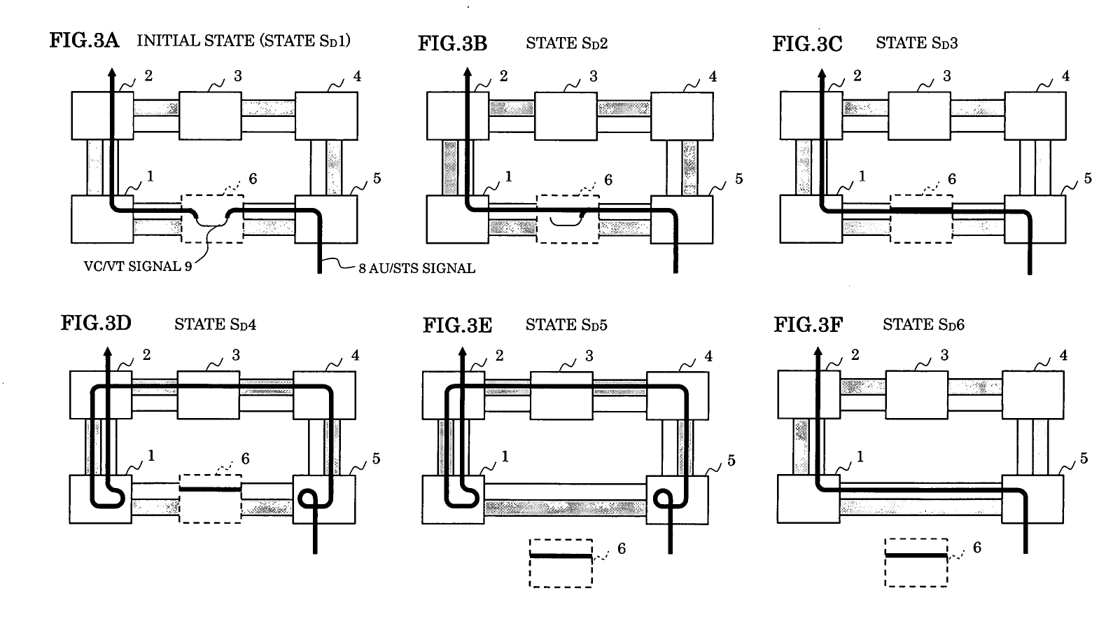

A schematic procedure when deleting the node 6 with the state S_{A}7 corresponding to the above-mentioned FIG. 2C being made an initial state, will now be described referring to FIGS. 3A-3F. In this case, since it is required that the node 6 is deleted after creating a higher-order through cross-connection, the following procedures are taken:

State S_{D}1: FIG. 3A

FIG. 3A shows an initial state at the time of the node deletion corresponding to FIG. 2C.

State S_{D}2: FIG. 3B

In the node 6 to be deleted, the higher-order cross-connect rolls the AU/STS signal. Thus, the lower-order through cross-connected state (see node 6 in the state S_{D}1 in FIG. 3A) is switched over to the higher-order through cross-connected state (see node 6 in the state SD² in FIG. 3B).

State S_{D}3: FIG. 3C

In the node 6 to be deleted, settings of cross-connection of the AU/STS signal branched by the higher-order cross-connect and the setting of the lower-order through cross-connection set by the lower-order cross-connect are deleted. Thus, only the higher-order through cross-connection remains within the node 6 as shown.

State S_{D}4: FIG. 3D

Then, the node ID of the node 6 to be deleted is deleted and the ring topology is restructured. Thus, the node 6 is logically deleted. Furthermore, the loop-back control is performed.

State S_{D}5: FIG. 3E

The node 6 to be deleted is physically deleted from the existing ring network.

State S_{D}6: FIG. 3F

The loop-back control is released.

It is to be noted that the processes in the states S_{D}4-S_{D}6 are the same as the prior art process for deleting the multiplexer having only the higher-order cross-connecting function from the ring network.

(3) Detailed Arrangement of Added/Deleted Node

Focusing attention on the node 6, that is an object of the addition/deletion in the schematic procedures of node addition and deletion as described in the above-mentioned (1) and (2), the detailed arrangement and various states of the node 6 will now be described.

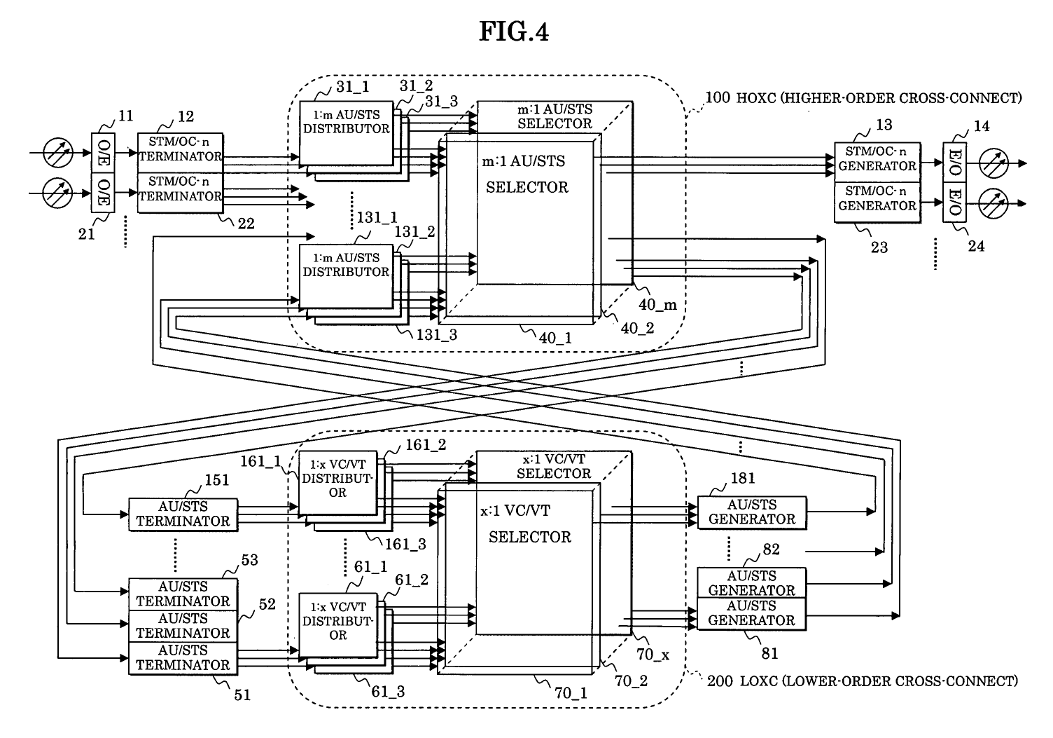

FIG. 4 shows a detailed arrangement of the node 6 shown in FIGS. 1A-1D, 2A-2C, and 3A-3F, provided with opto-electric converters (O/E) 11 and 21 for performing opto-electric conversion of the input signal, STM/OC-n terminators 12 and 22 for performing a higher-order termination of the STM/OC-n signal and for outputting an AU/STS signal, 1:m AU/STS distributors 31_1-31_3 . . . 131_1-131_3 for distributing the inputted single channel of the AU/STS signal to “m” channels, m:1 AU/STS selectors 40_1-40_m for selecting only one channel from the inputted “m” channels of the AU/STS signal to be outputted to a predetermined channel, STM/OC-n generators 13 and 23 for generating the STM/OC-n signal from the AU/STS signal, and electro-optical converters 14 and 24 for performing an electro-optical conversion to output a signal.

Also, to the m:1 AU/STS selectors 40_1-40_m, AU/STS terminators 51-53 . . . 151 for terminating the AU/STS signal (converting higher-order to lower-order) and for outputting the VC/VT signal are connected as shown. Moreover, 1:x VC/VT distributors 61_1-61_3 . . . 161_1-161_3 for distributing the inputted single channel of the VC/VT signal to “x” channels, x:1 VC/VT selectors 70_1-70_x for selecting only one channel from the inputted “x” channels of the VC/VT signal to be outputted to a predetermined channel, and AU/STS generators 81, 82, . . . , 181 for generating the AU/STS signal from the VC/VT signal (converting lower-order to higher-order) are connected as shown.

Among these, the 1:m AU/STS distributors 31_1-31_3 . . . 131_1-131_3 and the m:1 AU/STS selectors 40_1-40_m compose a higher-order cross-connect (hereinafter, occasionally referred to as HOXC) 100, having “m” outputs for “m” inputs, and cross-connects the AU/STS signal that is the higher-order synchronous network signal of the SDH/SONET inputted from any of the higher-order input channels to be cross-connected to any of the higher-order output channels.

Also, as shown, since the output side of the 1:m AU/STS distributor 31_1 are respectively connected to the input side of each of the m:1 AU/STS selectors 40_1-40_m, for example, if both of the m:1 AU/STS selectors 40_1 and 40_m select the input channels connected to the output side of the 1:m AU/STS distributor 31_1, the higher-order cross-connect 100 outputs the input signal from a single highe-order input channel branched to a plurality of the higher-order output channels, thereby realizing the “bridge” function.

Moreover, when the above-mentioned m:1 AU/STS selector 40_1 changes, from a state where the input channel connected to the output side of the 1:m AU/STS distributor 31_1 is selected, to select e.g. an input channel connected to the output side of the 1:m AU/STS distributor 131_3, as the higher-order cross-connect 100, a higher-order input channel cross-connected to the higher-order output channel is switched over to a different higher-order input channel, thereby realizing the “roll” setting function.

Also, the 1:x VC/VT distributor 61_1-61_3 . . . 161_1-161_3 and the x:1 VC/VT selectors 70_1-70_x compose the lower-order cross-connect (hereinafter, occasionally referred to as LOXC) 200, having “x” outputs for “x” inputs, and cross-connects the VC/VT signal that is the lower-order signal capable of being multiplexed into the higher-order synchronous network signal (AU/STS signal) input from any of the lower-order input channels to be cross-connected to any of the lower-order output channels.

Also, as shown, the lower-order cross-connect 200 has lower-order input channels (input side of 1:x VC/VT distributors 61_1-61_3 . . . 161_1-161_3) connected to a part of higher-order output channels of the higher-order cross-connect 100, and the lower-order output channels (output side of AU/STS generators 81,82, . . . ,181) connected to a part of higher-order input channels of the higher-order cross-connect 100.

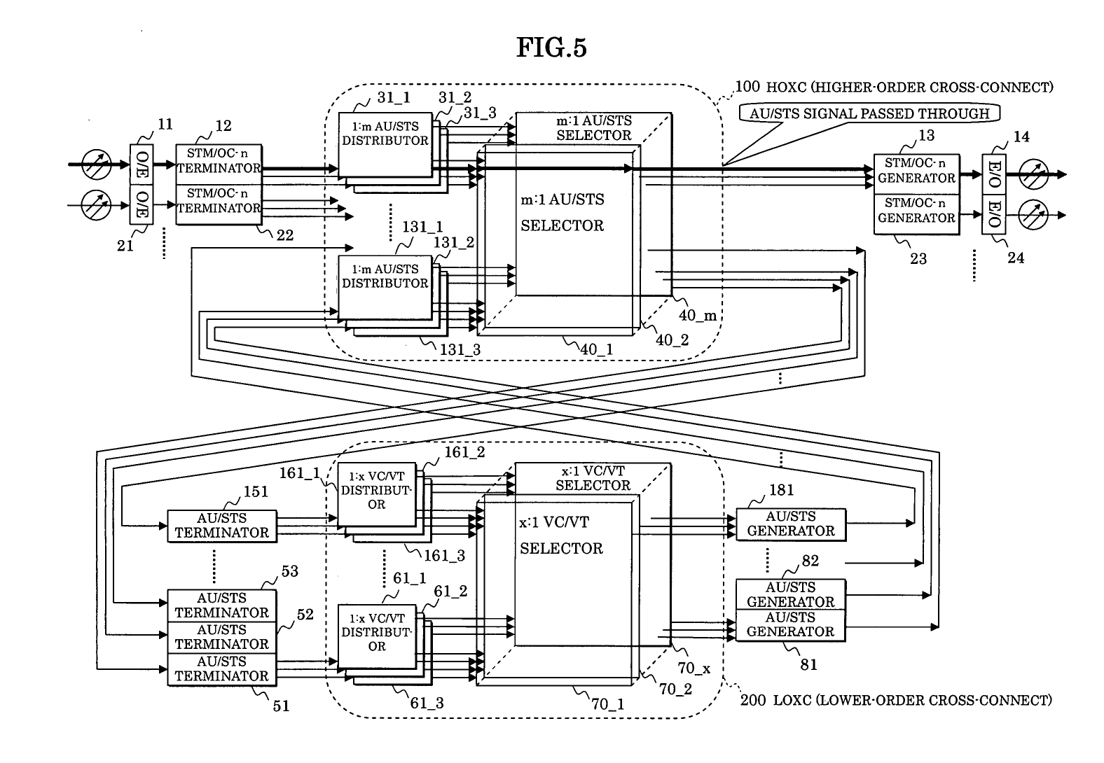

Each state of the node 6 in FIGS. 1D and 2A-2C when adding the node 6 to the ring network will be described referring to FIGS. 5-8. It is to be noted that the arrangement of FIGS. 5-8 are the same as that of FIG. 4.

Higher-Order Through Cross-Connection Only State: FIG. 5

FIG. 5 shows the details of the node 6 in the state S_{A}4 shown in FIG. 1D. At this time, for example, as shown by the thick arrow, the signal inputted from the optical transmission line to the opto-electric converter 11 passes the STM/OC-n terminator 12 and the 1:m AU/STS distributor 31_1, and passes through the m:1 AU/STS selector 40_1 to be outputted to the optical transmission line from the STM/OC-n generator 13 and the electro-optical converter 14.

Namely, the HOXC 100 through cross-connects the AU/STS signal.

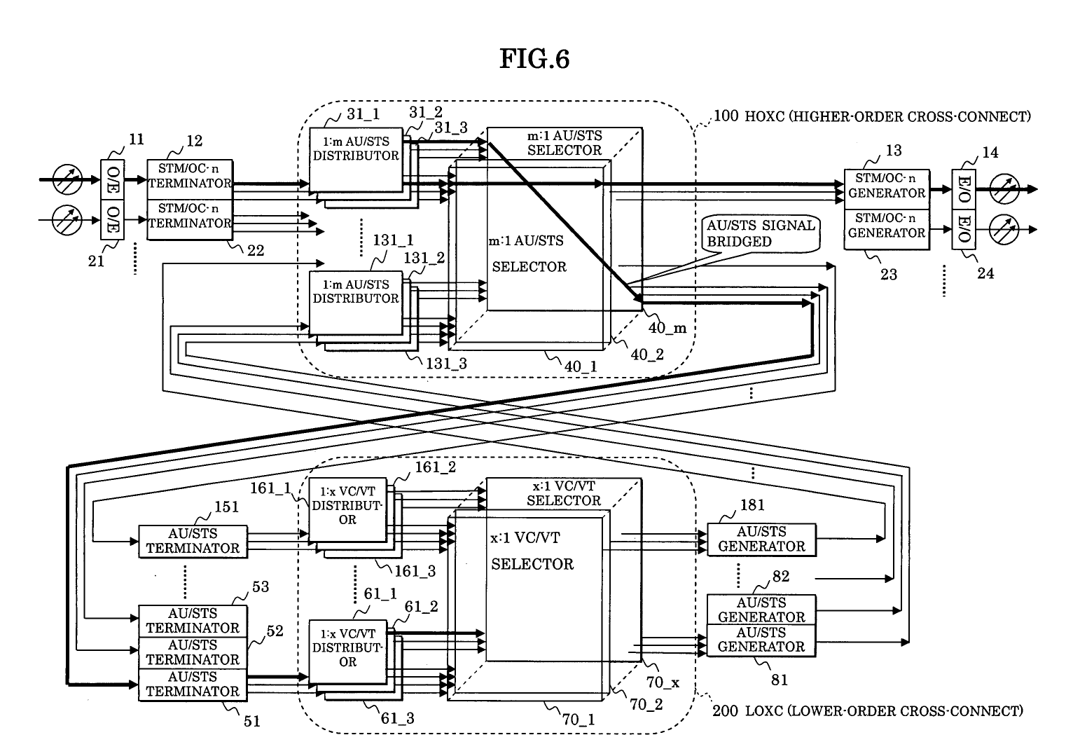

AU/STS Signal-Bridged State: FIG. 6

FIG. 6 shows the details of the node 6 in the state S_{A}5 of FIG. 2A. At this time, in addition to the through cross-connection described in the above-mentioned FIG. 5, for example, the signal from the 1:m AU/STS distributor 31_1 is cross-connected by the m:1 AU/STS selector 40_m as shown, inputted to the AU/STS terminator 51, and further passes the 1:x VC/VT distributor 61_1 to be inputted to the x:1 VC/VT selector 70_x.

This can be realized by the setting of the m:1 AU/STS selector 40_m.

Namely, the HOXC 100 bridges the AU/STS signal.

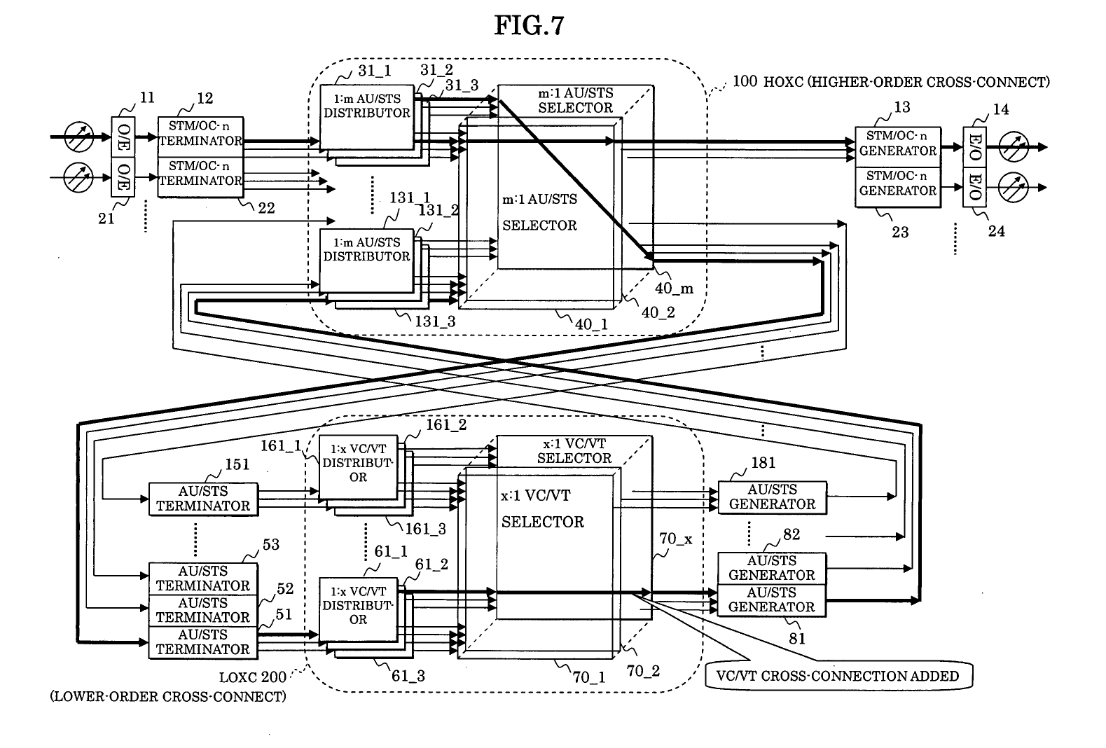

Lower-Order Through Cross-Connection Added State: FIG. 7

FIG. 7 shows the details of the node 6 in the state S_{A}6 of FIG. 2B. At this time, for example, since the x:1 VC/VT selector 70_x is set for a through cross-connection, the signal in the state of the above-mentioned FIG. 6 having passed the 1:x VC/VT distributor 61_1 and having inputted to the x:1 VC/VT selector 70_x is inputted to the m:1 AU/STS selector 40_1 by way of the AU/STS generator 81 and the 1:m AU/STS distributor 131_3.

Namely, the LOXC 200 through cross-connects the VC/VT signal. It is to be noted that at this time, the above-mentioned higher-order through cross-connection in the HOXC 100 is unchanged.

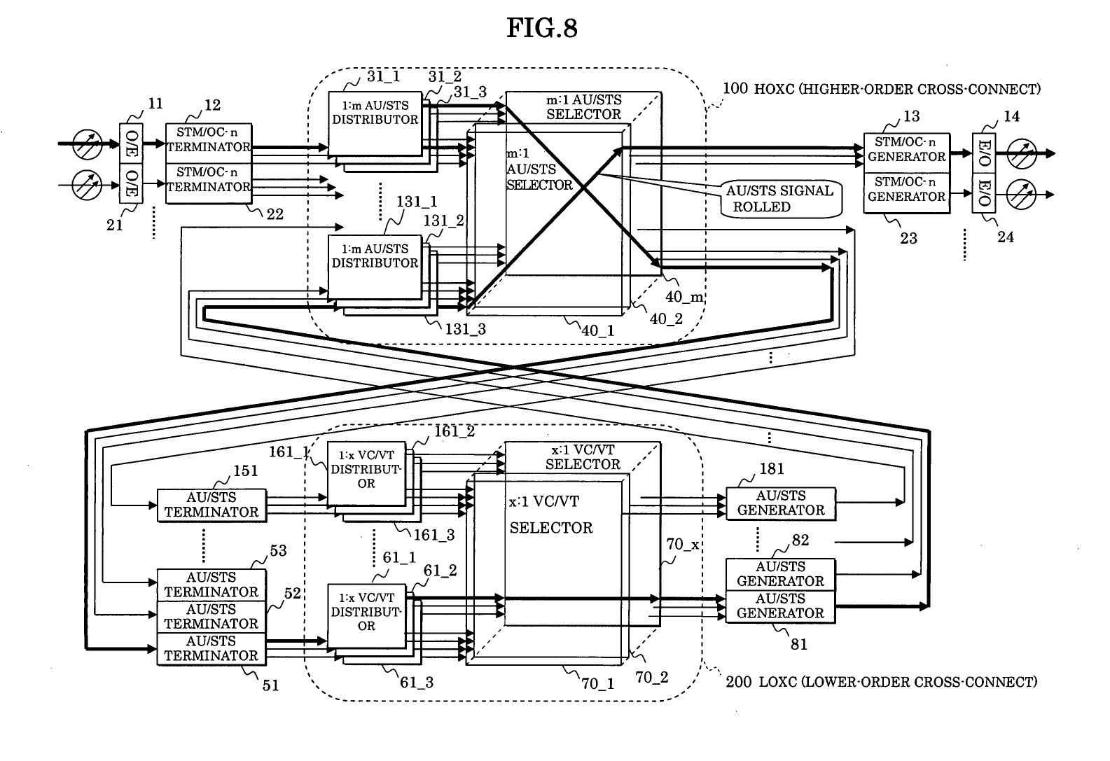

Lower-Order Through Cross-Connection Only State: FIG. 8

FIG. 8 shows the details of the node 6 in the state S_{A}7 of FIG. 2C. At this time, for example, for the input side of the m:1 AU/STS selector 40_1, the setting is changed so that the signal is selected not from the 1:m AU/STS distributor 31_1 but from the 1:m AU/STS distributor 131_3.

Namely, the HOXC 100 rolls the AU/STS signal. Thus, the above-mentioned higher-order through cross-connection in the HOXC 100 switches over to the lower-order through cross-connection in the LOXC 200.

As described above, in the node 6, the change from the state S_{A}4 of FIG. 5 to the state S_{A}7 of FIG. 8 can be achieved by only changing the settings of the m:1 AU/STS selectors 40_1-40_m and the x:1 VC/VT selectors 70_1-70_x.

Also, the states of the node 6 to be deleted in each of FIGS. 3A-3C when deleting the node 6 from the ring network, are the same as those shown in FIGS. 8, 7, and 5, respectively, so that it is possible to create each state by only changing the settings in the m:1 AU/STS selectors 40_1-40_m and the x:1 VC/VT selectors 70_1-70_x.

Therefore, it is no longer required to set cross-connection of the VC/VT signal after once deleting the cross-connection setting of the AU/STS signal upon node addition, and to set cross-connection of the AU/STS signal after once deleting the cross-connection setting of the VC/VT signal upon node deletion addition as in the prior art, so that it is made possible to avoid a service interrupted state.

As described above a multiplexer and a usage thereof according to the present invention are arranged such that a higher-order cross-connect of the multiplexer inputs a higher-order synchronous network signal from any of higher-order input channels to be cross-connected to any of higher-order output channels, a lower-order cross-connect inputs a lower-order signal, which can be multiplexed into the higher-order synchronous network signal, from any of lower-order input channels to be cross-connected to any of lower-order output channels, and a part of the higher-order output channels and a part of the lower-order input channels are mutually connected as well as a part of the lower-order output channels and a part of the higher-order input channels are mutually connected. Therefore, it becomes possible to add and delete a multiplexer equipped with both of a higher-order cross-connecting function and a lower-order cross-connecting function to/from a ring network without involving a service interruption.

In this case, nodes in the ring network except the multiplexer to be added or deleted do not necessarily have the arrangement of the multiplexer according to the present invention, thereby contributing to a smooth network restructuring.

What we claim is:

1. A multiplexer comprising:
a higher-order cross-connect for inputting a higher-order synchronous network signal from any of higher-order input channels to be cross-connected to any of higher-order output channels; and
a lower-order cross-connect for inputting a lower-order signal, which can be multiplexed into the higher-order synchronous network signal, from any of lower-order input channels to be cross-connected to any of lower-order output channels;
a part of the higher-order output channels and a part of the lower-order input channels being mutually connected as well as a part of the lower-order output channels and a part of the higher-order input channels being mutually connected.

2. The multiplexer as claimed in claim 1 wherein the higher-order synchronous network signal comprises an AU signal in an SDH or an STS signal in a SONET.

3. The multiplexer as claimed in claim 1 wherein the lower-order signal comprises a VC signal in an SDH or a VT signal in a SONET.

4. The multiplexer as claimed in claim 1 wherein upon addition of the multiplexer to a higher-order ring network, after being inserted into the ring network in a state where the higher-order cross-connect has established a through cross-connection between a first higher-order input channel and a first higher-order output channel, the higher-order cross-connect cross-connects a signal from the first higher-order input channel to be also branched to a second higher-order output channel different from the first higher-order output channel, the lower-order cross-connect establishes a through cross-connection between a lower-order input channel connected to the second higher-order output channel and a lower-order output channel connected to a second higher-order input channel different from the first higher-order input channel, and thereafter the higher-order cross-connect switches an input side corresponding to the first higher-order output channel from the first higher-order input channel over to the second higher-order input channel.

5. The multiplexer as claimed in claim 4 wherein upon deletion of the multiplexer from the ring network, the higher-order cross-connect switches the input side of a cross-connection corresponding to the first higher-order output channel from the second higher-order input channel over to the first higher-order input channel to establish a through cross-connection.

6. The multiplexer as claimed in claim 5 wherein the higher-order cross-connect deletes the cross-connection between the first higher-order input channel and the second higher-order output channel, and the lower-order cross-connect deletes the through cross-connection between the lower-order input channel and the lower-order output channel.

7. The multiplexer as claimed in claim 4 wherein the ring network comprises a BLSR ring network.

8. A method of adding a multiplexer claimed in claim 1 to a ring network comprising:
a first step of connecting the multiplexer to the ring network in a state where the higher-order cross-connect has established a through cross-connection between a first higher-order input channel and a first higher-order output channel;
a second step executed by the higher-order cross-connect, after an execution of the first step, of cross-connecting a signal from the first higher-order input channel to be also branched to a second higher-order output channel different from the first higher-order output channel;
a third step executed by the lower-order cross-connect, after an execution of the second step, of establishing a through cross-connection between a lower-order input channel connected to the second higher-order output channel and a lower-order output channel connected to a second higher-order input channel different from the first higher-order input channel; and
a fourth step executed by the higher-order cross-connect, after an execution of the third step, of switching an input side corresponding to the first higher-order output channel from the first higher-order input channel over to the second higher-order input channel.

9. The synchronization method as claimed in claim 8 wherein the first step includes a step of initializing the multiplexer.

10. The synchronization method as claimed in claim 8, further comprising a step, preceding the first step, of performing a loop-back control of the ring network, the first step including steps of physically connecting the multiplexer to the ring network, releasing the loop-back control, setting a node ID in the multiplexer, and restructuring a ring topology of the ring network.

11. A method of deleting the multiplexer added to the ring network according to the method claimed in claim 8 comprising:
a deletion preparing step, executed by the higher-order cross-connect, of switching the input side of a cross-connection corresponding to the first higher-order output channel from the second higher-order input channel over to the first higher-order input channel.

12. The method of deleting the multiplexer as claimed in claim 11, further comprising the steps, after an execution of the deletion preparing step, of deleting the node ID of the multiplexer, restructuring a ring topology of the ring network, performing a loop-back control of the ring network, physically deleting the multiplexer, and releasing the loop back control.

13. The method of deleting the multiplexer as claimed in claim 11, further comprising the step executed by the higher-order cross-connect, after an execution of the deletion preparing step, of deleting the cross-connection between the first higher-order input channel and the second higher-order output channel, and the step executed by the lower-order cross-connect deleting the through cross-connection between the lower-order input channel and the lower-order output channel.

14. The method of deleting the multiplexer as claimed in claim 12, further comprising the step executed by the higher-order cross-connect, after an execution of the deletion preparing step, of deleting the cross-connection between the first higher-order input channel and the second higher-order output channel, and the step executed by the lower-order cross-connect deleting the through cross-connection between the lower-order input channel and the lower-order output channel.
